(19) United States
(12) Patent Application Publication
(10) Pub. No.: US 2016/0300514 A1
(43) Pub. Date: Oct. 13, 2016

(54) LIGHTING SYSTEM FOR GLASS SURFACES

(71) Applicant: Flavia Cecilia QUIÑONES VAZQUEZ, Distrito Federal (MX)

(72) Inventors: Flavia Cecilia Quinones Vazquez, Federal District of Mexico (MX); Jaime Bassegoda Trevino, Federal District of Mexico (MX)

(21) Appl. No.: 15/036,276

(22) PCT Filed: Aug. 14, 2015
(86) PCT No.: PCT/IB2015/056188

§ 371 Date: May 12, 2016

(30) Foreign Application Priority Data
Aug. 14, 2014 (MX) MX/U/2014/000406

(51) Int. Cl. G09F 13/04; F21V 21/08; F21V 23/06; G09F 19/00; A47F 11/10

(52) U.S. Cl. CPC G09F 13/04; G09F 19/00; A47F 11/10; F21V 23/06; F21V 21/0808; F21Y 2101/02

(57) ABSTRACT

In accordance with the present invention, we have a lighting system for glass surfaces as commercial refrigerators, windows, doors, showcases etc., consisting of a main panel, an commercial display, a lighting system and a series of electrical conductives distributed over the back side of the main panel for supplying the lighting system with electric current from a power source, the former of which comprises a support base that houses a high-powered LED lamp and a diffusor lens that covers the lighting system in its entirety; and finally, fastening methods are used to attach the lighting system to the main panel, bring it into contact with the electrical conductives.

### CROSS-REFERENCE TO RELATED APPLICATION

This Application is a Section 371 National Stage Application of International Application No. PCT/1B2015/056188, filed Aug. 14, 2015, which is incorporated by reference in its entirety and published as WO 2016/024250 A1 on Feb. 18, 2016 and which claims priority of Mexican Application No. MX/u/2014/000406, filed Aug. 14, 2014.

### FIELD OF THE INVENTION

The illustrated embodiments of the present invention refer to lighting systems on glass surfaces. These are specifically lighting systems attached to doors or glass surfaces that illuminate the interior and exterior of same.

### BACKGROUND OF THE INVENTION

Excellent lighting is essential for attracting customers. Without a doubt, the way merchandise is presented is a key determining factor in the amount of targeted sales. This is why it is important that strategic displays are well-lit and the establishment has the right colors.

Take into account that display lighting brings out the best attributes of the retail merchandise. Another aspect to consider is the strategic placement of the display cases in a way that easily attracts the attention of the customer. And lastly, regarding the colors in the establishment, an attractive aesthetic makes the customer feel like he or she is in another environment. The key characteristic to consider is how the display case is illuminated. Lighting should be discrete so that it does not detract from the customer's view, but at the same time, be able to efficiently illuminate objects on display.

Opinions on the topic differ among interior decorators. Some decorators stress that light is the most important element while other assert that the most important design element is the display case, while others emphasize the color combinations. To this end, the present invention seeks to provide a lighting system that is as efficient as it is pleasing to the eye, while at the same time meeting the expectations of the client in terms of not only efficiency, but of appearance, functionality and practicality.

Currently, there are several types of illumination systems for glass. For example, the utility model CN203275833U consists of a piece of secure and intelligent tinted glass composed of a glass body, which in turn is made up of at least two substrate layers of glass, a liquid layer that rests on top of the surface of one substrate glass layer, and another layer consisting of a insulated liquid coating and layer of a binding agent on the other side of the substrate layer; one transparent semiconductive metal coating in addition to the liquid layer and one transparent conductive coating adhered to the binding agent layer; conductive strips are attached to the surfaces on opposite sides of the double-sided glass body, connected to power supply terminals which lead to the exterior. In contrast to said utility model, the present invention does not require conducting surfaces to transmit the current from a power source to the lighting system; in addition, the utility model does not disclose a lighting system that features interior illumination of the display case.

The utility model DE202004011355U1 comprises a reflector system based on LED lamps. The top of the arrangement is encircled by an inserted reflector and supported by a plastic base; in addition, tracks can be mounted on said base for feeding wires, cables or reels. In contrast to the present invention, said utility model DE202004011355U1 does not describe its application for use on top of a glass surface; in addition, it does not disclose e a lighting system as described in the present invention.

Patent MX 309092 discloses a lighting system designed to light the inside of the kind of cabinets used in commercial refrigeration units with glass doors; the system is made up of serial LED connections mounted on a printed circuit board (PCB); the bundle is inserted into a diffusor tube with favorable geometric properties for optimal light emission, and whose geometry is customizable to the lining installed inside the cabinet door frames. The LEDs are supplied with a power source that can either be a current or voltage, and depending on the arrangement of the LEDs in the interior door lining, it enables optimum illumination of the articles on display. In contrast to the present invention, said patent only allows the lighting system to be attached to door frames, while the present invention allows the lighting system to me mounted on the glass surface or on the glass door itself without requiring a support frame for installation.

None of the existing documents describe a lighting system for glass surfaces composed of a main panel with a series of electrical conductives and a lighting system connected to them that illuminates retail merchandise. Therefore, a need exists for a lighting system for glass surfaces that overcomes all the inconveniences posed by the previously developed systems.

### BRIEF DESCRIPTION OF THE FIGURES

The aforementioned features and advantages associated with this invention are better explained in the following detailed description and are accompanied by illustrative figures and drawings:

FIG. 1 shows a frontal view of the glass surface.

FIG. 2 shows a back view of a glass surface.

FIG. 3 shows a back perspective view of the glass Surface.

FIG. 4 shows a frontal perspective view of the glass Surface.

FIG. 5 shows an expanded frontal view of the lighting system.

FIG. 6 shows an expanded back view of the lighting system.

FIG. 7 shows a perspective view of the support base.

FIG. 8 shows an expanded back view of one possible arrangement of the lighting system.

FIG. 9 shows a lateral cross-section of the lighting system attached to a glass Surface.

FIG. 10 shows a close-up of the front side of the conceptual lighting system.

FIG. 11 shows a close-up of the back side of the conceptual lighting system.

FIG. 12 shows a frontal view of one embodiment of the present invention.

FIG. 13 shows a frontal view of another embodiment of the present invention.

FIG. 14 shows a frontal view of another embodiment of the present invention.

### DETAILED DESCRIPTOR

### Objectives

The principal objective of the present invention is: to provide a lighting system that can be mounted to glass surfaces.

The second objective of the present invention is: to provide a lighting system that can be attached to the interior surface of any door, window or glass pane in any display component.

The third objective of the present invention is: to provide a lighting system that allows the connection of a series of electrical conductives to a glass surface.

The fourth objective of the present invention is: to provide a lighting system that allows the coupling of a light-emitting component with electrical conductives.

The fifth objective of the present invention is: to provide fastening methods for mounting the light-emitting component to the glass surface.

The sixth objective of the present invention is: to provide a diffusor lens covering the light-emitting component.

The seventh objective of the present invention is: to provide a support base that also serves as housing for the light-emitting component.

The eight objective of the present invention is: to provide a support base for the purposes of allowing reflected light to escape.

The ninth objective of the present invention is: to provide a reflective cover.

The tenth objective of the present invention is: to provide a base for the diffusor lens.

The eleventh objective of the present invention is: to provide a commercial display over the glass surface flush with the lighting system.

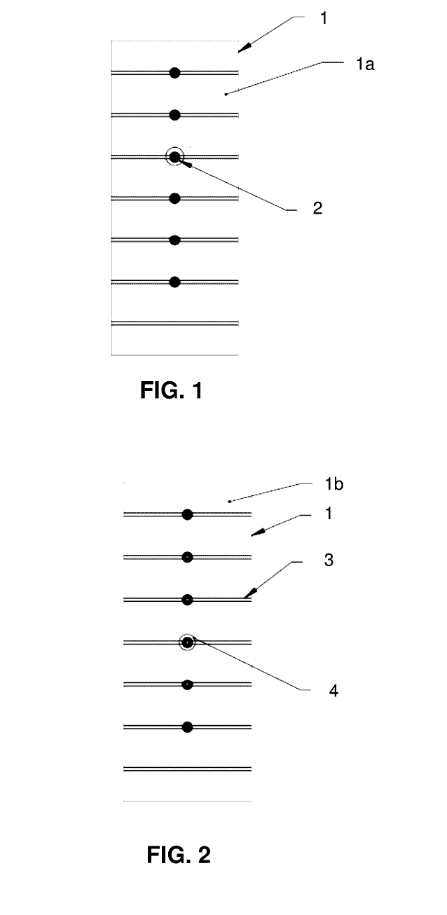

FIG. 1 shows a frontal view of a glass surface.

It comprises a main panel (1) made of glass and substantially flat; in the preferred embodiment of the present invention, said main panel (1) additionally comprises a rectangular form, which can be any variation, size, dimension or made of any kind of material. Assuming the preferred embodiment, a series of commercial displays are arrangement along its length (2) (described below) across the front side (1a) of the main panel (1); in the preferred embodiment of the present invention, the commercial displays (2) are arranged along the longitudinal symmetry axis of the main panel (1) at equal distance.

FIG. 2 shows a back view of a glass surface.

As can be seen in FIG. 2), the back side (1b) of the main panel (1) consists of a series of electrical conductives (3) arranged at equal distance from one another. Finally, a lighting system (4) (described below) is located at the same level or flush with the commercial displays (2) across the back side (1b) of the main panel (1),

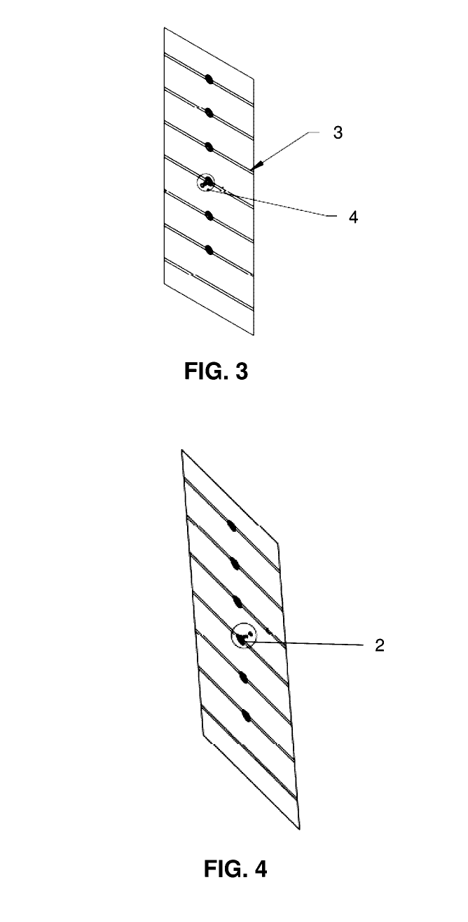

FIGS. 3 and 4 show back and frontal perspective views, respectively, of the glass surface.

Said FIGS. 3 and 4 provide a clear view of the electrical conductives (3), lighting systems (4) and commercial displays (2). This type of main panel (1) is commonly used as a door and/or window in product or shop window displays. A preferred application of the present invention is used to illuminate the contents of shop window displays and/or display cases utilizing a lighting system (4), hence it should be stressed that the main panel (1) should be made of glass, as this material lends practicality, elegance and is affordable; in addition, the direct contact of the electrical conductives (3) and the lighting system (4) with the main glass panel (1) provides favorable conditions for the dissipation of heat, preventing accidental overheating of the lighting system (4), or in case of defects in the system, prevents the main panel from being burnt or singed (1).

It is important to underscore that utilizing glass in the preferred embodiment of the present invention (while any other material could theoretically be used as long as it fulfills the requirements of the present invention), since this material has an insulating function; however, even though it is widely known that when we increase the temperature of glass, some of the material's electrons will acquire enough energy to be able to make changes to the material resulting in the emission of light, which therefore makes the material a conductive. The energy the lighting system (4) dissipates is enough to heat a surface that is made of polymers, for instance, but much less than the temperature required to convert glass into a conductive.

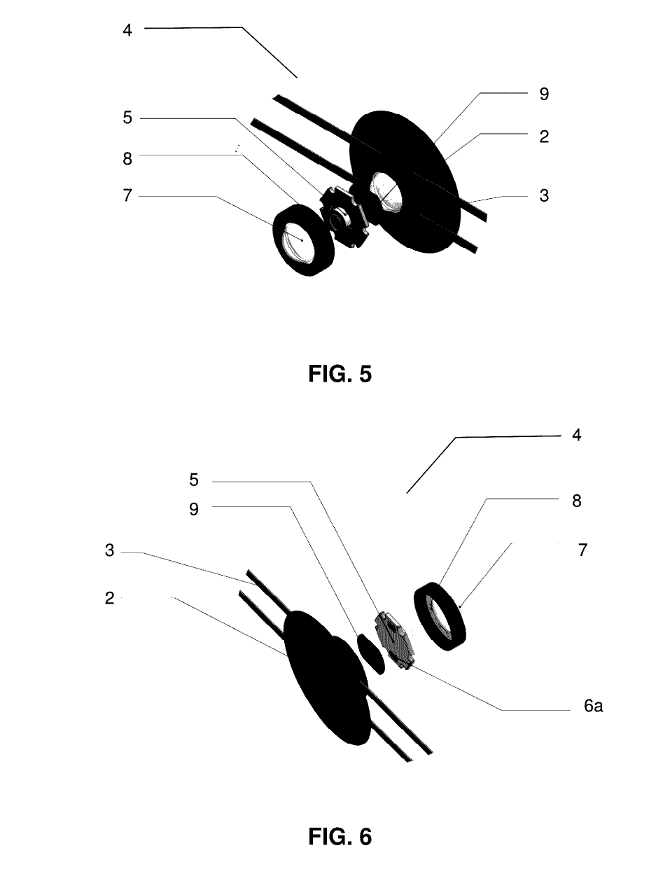

FIG. 5 shows an expanded frontal view of the lighting system.

As can be seen in FIG. 5, the lighting system (4) is made up of a high-powered LED lamp (5), which is attached to a support base (6); a diffusor lens (7) attached to a base (8), which can be attached to the support base (6); finally, said support base (6) is attached to the main panel (1) using fastening methods (9). Said fastening methods (9) can be mounted using bonding material like quick-dry polymer glues, silicon, or resin compounds. In the preferred embodiment of the present invention, adhesive bonding material consisting of double-sided strip (9) is used to ensure that the fastening methods (9) can be attached not only to the main panel (1) but to the support base (6) as well. Said adhesive used in the preferred embodiment of the present invention is classified under:

### Polyurethane Adhesives

Due to the high level of elasticity and stretchability characterized by these type of adhesives, polyurethane adhesives are a good option for bonding crystal or glass panes that must be reinforced and be kept sturdy. To ensure a strong and long-lasting bond, apply specially formulated primers before applying the polyurethane adhesive to the crystal.

### Modified Silane Adhesives

The use of modified silanes for crystal adhesives is expanding in the industrial sector, as well as for repairs and maintenance, due to its high resilience to ultraviolent light, as well as to its low toxicity, which, in contrast to polyurethane adhesives, are free of MDI.

### Silicone Adhesives

As in the case of all modified silanes, silicone adhesives or glues exhibit high resistance to ultraviolet light and are highly stretchable.

FIG. 5 additionally shows electrical conductives (3) that come into contact with pads (described below) present on the back of the support base (6); in addition, it shows the area consisting of the commercial display (2); it is important to note that said commercial display (2) is placed at the same level flush with the lighting system (4) but only on the front side (1a) of the main panel (1).

FIG. 6 shows an expanded back view of the lighting system.

As can be seen in FIG. 6, the support base (6) that houses the high-powered LED lamp (5) has a printed circuit (not shown in the images) that comes into contact with the terminals of the LED lamp (5) and at least two contact pads (6a) placed on two opposite sides of the support base (6). Said contact pads (6a) come into contact with the electrical conductives (3) that transmit the energy from one power or battery source (not shown in the images) to the LED lamps (5) to supply them with energy which enables them to emit light.

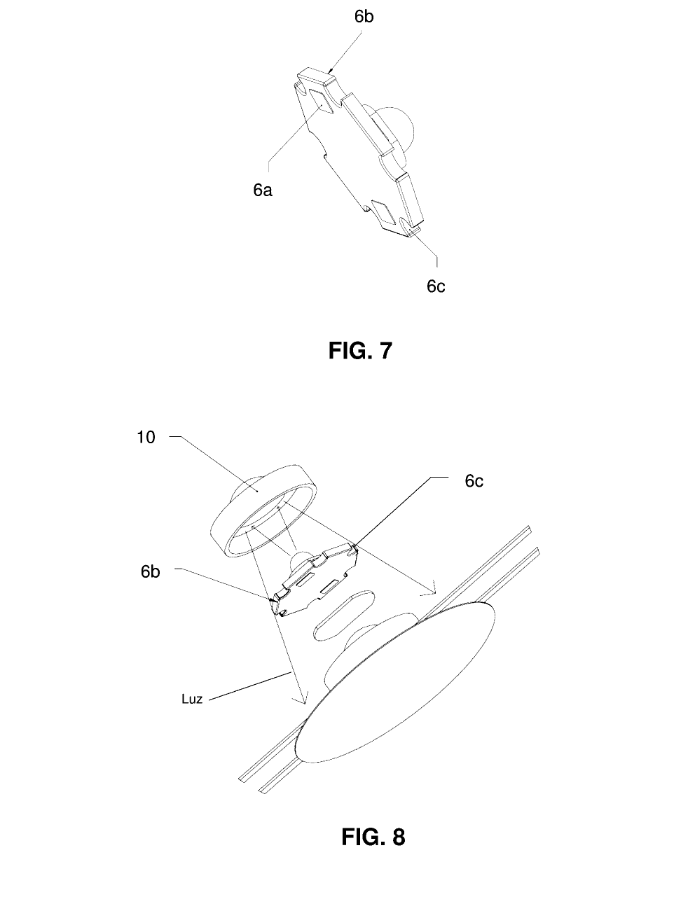

FIG. 7 shows a perspective view of the support base. As can be seen in FIG. 7, the support base exhibits a flat regular polygon-shaped body with six sides (but can be of any variation), with straight edges (6b), each separated by a semicircular slot (6c), which has a space for allowing light to escape. Additionally, said FIG. 7 shows contact pads (6a) which are featured as a set of two in the preferred embodiment of the present invention (6a) on opposite sides of the support base (6); nevertheless, said pads (6a) can be placed at any point along the support base (6) for the purpose of connecting the conductives (3) in any defined arrangement along the main panel (1). It is worth noting that in the preferred embodiment of the present invention, the support base (6) is made of porcelain, but can consist of any material or in any variation, size or dimension.

FIG. 8 shows an expanded back view of one particular embodiment of the lighting system.

As can be seen in FIG. 8, the diffusor lens (7) is replaced by a reflective cover (10) that allows light to reach the exterior of the case, directing the light beam toward the support base (6), which in turn allows the light to pass through the slots (6c), projecting the light beam onto the commercial display (2). It is worth noting that in this case, the commercial display (2) is made of luminescent material that gives off light without building up heat; which allows the information and/or images printed on its surface to be displayed without letting light escape to the exterior.

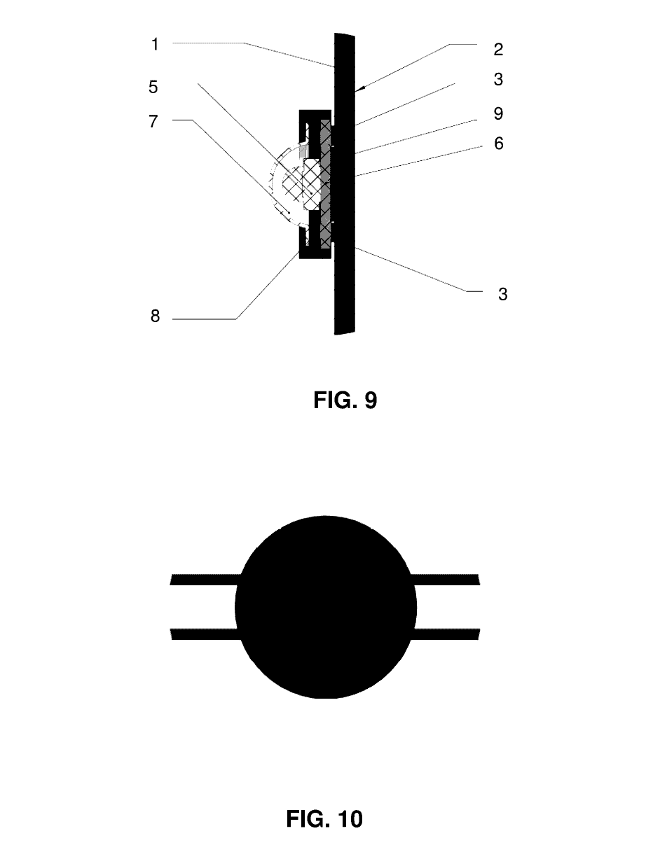

FIG. 9 shows a lateral sectional view of the lighting system attached to the glass surface.

As can be seen in FIG. 9, the lighting system (4) is attached to any point along the main panel (1) just above the conductives (3); and it is also worth point out that said conductive lines can be installed using any manner of electrical conductive such as metals, cables, fiber optic, etc.

In the preferred embodiment of the present invention, the conductive lines (3) are attached in pairs onto the back side (1b) of the main panel (1); said parallel lines (3) are placed accordingly to allow connection to the pads (6a) located on the support base (6). Said parallel separation between the conductive lines (3) permits the placement of fastening methods (9) which, in the preferred embodiment of the present invention, are made up of a double-sided adhesive strip, allowing said fastening method (9) to be attached to the main panel (1) just between the parallel conductives (3) on one side, while holding the support base (6) on the other side. Once the support base (6) is attached to the main panel (1), an LED (5) is also placed onto said base (6) using a socket-type component (not shown in the images), allowing free contact between the LED lamp filaments (5) and the built-in circuit that comes into contact with the pads (6a). Finally, a diffusor lens (7) is attached to the support base (6) at the bottom (8).

In the preferred embodiment of the present invention, the diffusor lens (7) channel the light from the LED lamp (5) toward the exterior, preventing overheating of the products on display; in addition, said diffusor lens (7) directs the projected light beam into a given direction. Finally, the base of the lens (8) covers the lighting system (4) in its entirety, which protects the display from the elements such as rain, dust, wind or ultraviolet light.

FIG. 10 shows a close-up of the frontal side of the conceptual lighting system.

As can be seen in FIG. 10, the commercial display (2) completely covers the lighting system (4) so that it is not visible from the outside of the main panel (1); in addition, any kind of information or images can be printed on said commercial display (2); and said sign (2) can be made of any opaque or translucent material.

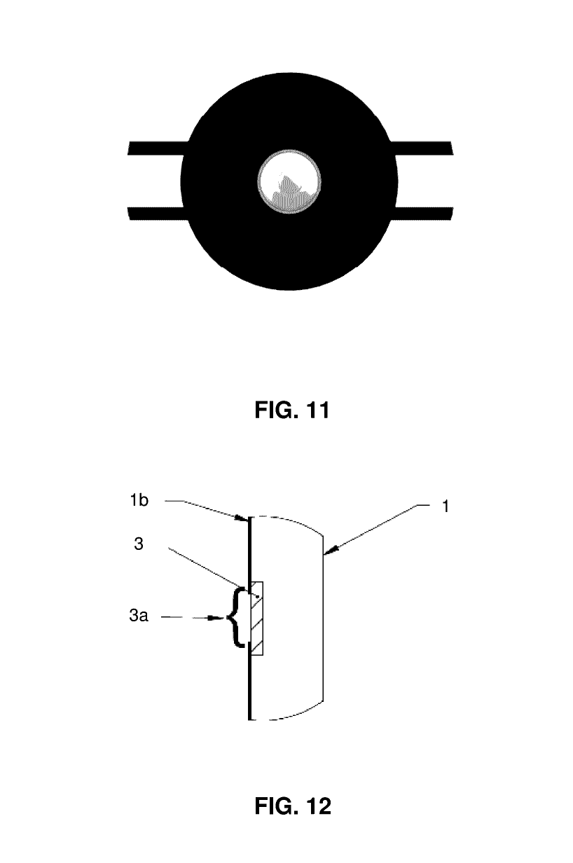

FIG. 11 is a close-up of the back side of the conceptual lighting system.

As can be seen in FIG. 11, the lighting system (4) is just behind the commercial display (2); however, said lighting system (4) can be placed anywhere along the back side (1b) of the main panel (1), provided that it does not obscure any part of the commercial display (2). It is important to point out that said commercial display (2) can be of any shape, size or material.

FIG. 12 shows a frontal view of one embodiment of the present invention.

As can be seen in FIG. 12, the electrical conductive (3) is embedded in the main panel (1) exposing only one contact (3a). Said embodiment of the present invention allows the connection of the lighting system (4) that lets the installer hide the electrical conductives from view.

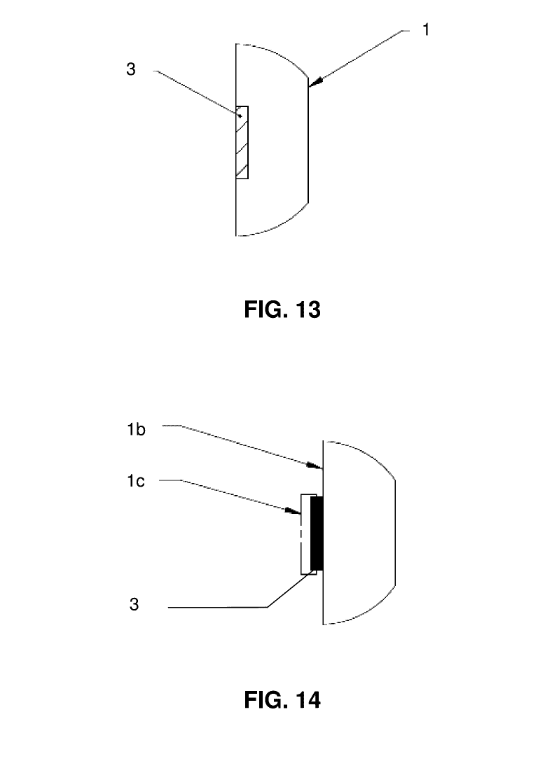

FIG. 13 shows a frontal view of one embodiment of the present invention.

As can be seen in FIG. 13, the electrical conductives (3) are completely embedded in the main panel (1). One characteristic of said embodiment is the connection of the lighting system (4) to exposed terminals (not shown in the images) that emerge from one side of the main panel (1).

FIG. 14 shows a frontal view of one embodiment of the present invention.

As can be seen in FIG. 14, the electrical conductive (3) is fully attached to the inner side (1b) of the main panel (1) as in the preferred embodiment of the present invention; however, in said embodiment, the conductive (3) is coated with an insulating varnish (1c), which serves to protect the electrical conductive (3) from the weather.

One embodiment of the invention is based on providing a lighting system connected to a glass surface.

Another embodiment of the invention is based on providing a lighting system connected to any transparent surface.

Another embodiment of the invention is based on providing a lighting system that allows any type of light bulb to be connected to it.

Another embodiment of the invention is based on providing a lighting system comprising electrical conductives such as metal rods, cables, wires, conductive tape, fiber optic, conductive paint, conductive adhesive, etc.

Another embodiment of the invention is based on providing a lighting system that enables the lighting of the inside of any cabinet, refrigerator, display case, and supply cabinet with glass doors.

Another embodiment of the invention is based on providing a lighting system that reflects light onto the commercial display.

Another embodiment of the invention is based on providing a lighting system that allows any kind of diffusor to be connected to it.

Another embodiment of the invention is based on providing a lighting system that allows any kind of reflective cover to be attached to it.

Another embodiment of the invention is based on providing a series of electrical conductives parallel to the main panel.

Another embodiment of the invention is based on the utilization of an adhesive bonding material, such as quick-dry polymeric, or silicone glue, or otherwise any type of water-, wind-, or dust-resistant adhesive.

Another embodiment of the invention is based on creating an openings in the main panel for subsequent connection of electrical conductives.

Another embodiment of the invention is based on the use of electrical conductives embedded into the main panel.

Another embodiment of the invention is based on the use of electrical conductives embedded into the main panel, whereby the contact is above the surface.

Another embodiment of the invention is based on the use of electrical conductives attached to the main panel.

Another embodiment of the invention is based on the use of a translucent commercial display.

Another embodiment of the invention is based on the use of an opaque commercial display that blocks light from reaching the exterior of the case.

Although the subject matter has been described in language specific to structural features and/or methodological acts, it is to be understood that the subject matter defined in the appended claims is not necessarily limited to the specific features or acts described above. Rather, the specific features and acts described above are described as example forms of implementing the

1. A system for glass surfaces, the system comprising:
a main panel;
a commercial display; and
a lighting system, the lighting system comprising a series of electrical conductive elements placed along the back side of the main panel for supplying the lighting system with electric currents from a power source, the former of which comprises a support base, a high-powered LED, a diffusor lens, and fastening mechanisms to establish a connection therebetween.

2. The system for glass surfaces of claim 1; wherein the series of electrical conductive elements are distributed in an arrangement equally apart from one another.

3. The system for glass surfaces of claim 1; further comprising a series of commercial displays attached to the front of the main panel.

4. The system for glass surfaces of claim 3; wherein the commercial displays are adjacent the lighting system on its opposite side.

5. The system for glass surfaces of claim 1; wherein the fastening mechanisms are installed using quick-dry glues on both sides, and are made of polymeric or silicone adhesives, or resin compounds.

6. The system for glass surfaces of claim 1; wherein the support base features a printed circuit connected to at least two contact pads.

7. The system for glass surfaces of claim 6; wherein the contact pads are placed on two opposite sides of the support base.

8. The system for glass surfaces of claim 1, wherein the support base has a flat surface in a regular polygon shape of six sides with straight edges and where each straight edge is separated by a semicircular slot, which allows light to escape.

9. The system for glass surfaces of claim 8; wherein the support base can be of any shape, size or material suitable for use with the system.

10. The system for glass surfaces of claim 1; wherein the diffusor lens has a lens base.

11. The system for glass surfaces of claim 1; wherein the diffusor lens can be substituted by a reflective cover.

12. The system for glass surfaces of claim 10; wherein the diffusor lens and the reflective cover can be of any shape, size or material.

13. The system for glass surfaces of claim 1; wherein the electrical conductives can be built into the main panel.

14. The system for glass surfaces of claim 1; wherein the electrical conductives can be built in the main panel such that a single point of contact is left with the surface of same.

15. The system for glass surfaces of claim 1; wherein the electrical conductives can be coated with a non-conductive varnish.

16. The system for glass surfaces of claim 1; wherein the electrical conductives can be connected to channels in the main panel.

17. The system for glass surfaces of claim 1; wherein the electrical conductive elements can be placed onto the main panel.

18. The system for glass surfaces of claim 11; wherein the diffusor lens and the reflective cover can be of any shape, size or material.
